(19) United States
(12) Patent Application Publication
(10) Pub. No.: US 2011/0107957 A1
(43) Pub. Date: May 12, 2011

(54) PLANNING SYSTEM AND METHOD

(76) Inventor: Deirdre C. Pizzoferrato, South Glastonbury, CT (US)

(21) Appl. No.: 13/000,109

(22) PCT Filed: Jul. 2, 2009
(86) PCT No.: PCT/US09/49547

§ 371 Date: Dec. 20, 2010

Related U.S. Application Data
(60) Provisional application No. 61/078,177, filed on Jul. 3, 2008.

(51) Int. Cl. G09F 9/00

(52) U.S. Cl. 116/201; 116/308

(57) ABSTRACT

A planning system that includes at least one non-functioning clock. Each of the at least one non-functioning clocks includes a settable hour placeholder and a settable minute placeholder in order to represent a specified time. The system also includes at least one informational item adapted to be associated with the at least one non-functioning clock. The informational item contains information relating to at least one of a food, activity, homework, or combination thereof and each item prompts a behavior of an individual at the specified time.

### CROSS-REFERENCE TO RELATED APPLICATION

The present application is a National Stage of International Application No. PCT/US2009/049547, filed Jul. 2, 2009, designating the United States and claiming priority to U.S. Provisional Application No. 61/078,177, filed Jul. 3, 2008, both of which are incorporated herein by reference in their entirety.

### BACKGROUND OF THE INVENTION

On average, children eat more and exercise less than the children of past generations. Childhood obesity plagues the youth of today. The etiology of childhood obesity is multifaceted and the influences are vast. Parents and caregivers struggle with a multitude of environmental factors that lead to the development of unhealthy habits in their children. Such factors include inactivity due to television watching and sedentary game playing, poor food choices, overextended parents, and the inability to communicate effectively with children.

The increase in sedentary behavior of children has decreased child participation in physical activities. Caregivers rely on television programming to exorbitant levels in order to pacify children. The sedentary habits established in a child's youth often continue in the child's adolescence and into adulthood.

Poor food choices are significant factors in the rise of childhood obesity. Many parents are overextended and have minimal time to prepare balanced nutritious meals for their children. Unfortunately, quick, processed snacks and meals have become the necessity to today's hurried culture. Unaware to some parents, most eating habits and food preferences are established in children before the age of five.

Parents struggle with effectively communicating with children. Parents often concede to irrational demands due to the inability of the parent to effectively reason and communicate with their child. The parent's concession may contribute to the formation of unhealthy habits. There is a need for a method and system to assist caregivers to cultivate healthy habits and behaviors in children.

Some existing systems to develop children's behavior track a particular behavior over the course of several days and either reward or punish a child based on the resultant data. Such systems may utilize charts, plans, or boards to monitor the child's behavior. However, such systems remove the participation of the intended child. This lack of child participation impedes the cultivation of personal responsibility, leaving the child conditioned only to the promise of a reward or the fear of punishment as their motive. The child's innate desire to maintain set behaviors fails to be adequately developed.

Further, charts and boards fail to effectively communicate intended goals due to the visually confusing presentation of the goals. For example, many systems include a multitude of rows, columns, pegs, and boxes in conjunction with a plurality of accessories such as chips, tokens, money, smiley/sad faces, stickers and treats. Since the caregiver manages the system, no sense of responsibility is imparted on the child. These systems also fail to encourage the child in the event of a personal setback or unexpected struggle.

Some systems develop a child's understanding of time and incorporate time management with activities as a method of educating. Such systems focus on the mechanics of time telling, with a secondary emphasis on time management. Such devices fail to incorporate healthy habits with the education of time management

There is a need for one system that educates a child to do physical activity, make good food choices, manage time, and learn responsibility to help minimize obesity in children

### SUMMARY

The above and other goals are accomplished according to one aspect of the invention wherein there is provided, a planning system, comprising: at least one non-functioning clock, wherein each of the at least one non-functioning clocks includes a settable hour placeholder and a settable minute placeholder in order to represent a specified time; and at least one informational item adapted to be associated with the at least one non-functioning clock, each item containing information relating to at least one of a food, activity, homework, or combination thereof and each item prompting a behavior of an individual at the specified time.

According to a further aspect of the invention, there is provided a method for planning, comprising: setting an hour-hand placeholder and a minute-hand placeholder of at least one non-functioning clock to represent a specified time in relation to a working clock in real-time; choosing an informational item, wherein the informational items include information relating to one of a food, activity, homework, or combination thereof; associating the informational item with the specified time of the at least one non-functioning clock; and completing a task associated with the informational item when the specified time of the non-functioning clock is the same time as the working clock.

Embodiments of the invention entrust a child with personal responsibilities that include making decisions, setting goals and managing time, whereas prior inventions have maintained the parent/caregiver as the manager over the desired outcomes in the child. Embodiment of the invention moderate and/or modify—not prohibit or deny—behaviors and activities of the child.

The success in maintaining the system acts as the reward for the child through achieving set goals. There are no punishments involved in non-compliance or failure to achieve goals other than the missed opportunity to engage in a desirable activity or behavior (the set goal). Because the child manages the system, the child is held personally accountable for any failures. This sense of personal responsibility and autonomy helps build self-esteem and self worth, essential for maintaining long-lasting healthy habits and behaviors.

For parents and caregivers, the system provides structure, organization and control over the child's behaviors. Such behaviors include: unhealthy eating and snacking habits; television watching and video gaming; and unstructured and disorganized daily routines, which further perpetuate these unhealthy habits.

For parents and caregivers, ongoing support is provided through an interactive web site where related concerns and questions are provided through an interactive forum. This forum will provide parents and caregivers support to persevere in the event of potential obstacles. The site will also provide useful information and education on nutrition, tips on increasing exercise, and any other pertinent information with regards to raising healthy children. This sense of community through the commonality of raising healthy children can help bridge the gap between any longitudinal, socioeconomic, racial or religious barriers that may be present which may act as barriers to seeking help for overweight and obese children and families.

### BRIEF DESCRIPTION OF THE DRAWINGS

The present invention will be more readily understood from the following detailed description when read in conjunction with the accompanying drawings, in which:

FIG. 1 is representation of the device according to an embodiment of the invention;

FIGS. 2-7 are representations of Snack informational items according to an embodiment of the invention;

FIG. 8 is a representation of a housing for the Snack informational items according to an embodiment of the invention;

FIGS. 9-12 are representations of Activity informational items according an embodiment of to the invention;

FIG. 13 is a representation of a housing for the Activity informational items according to an embodiment of the invention;

FIG. 14 is a representation of a housing for the After School informational items according to an embodiment of the invention;

FIGS. 15-20 are representations of After School informational items according an embodiment of to the invention; and

FIG. 21 represents a computer able to access an Interactive website forum relating to the device.

### DETAILED DESCRIPTION

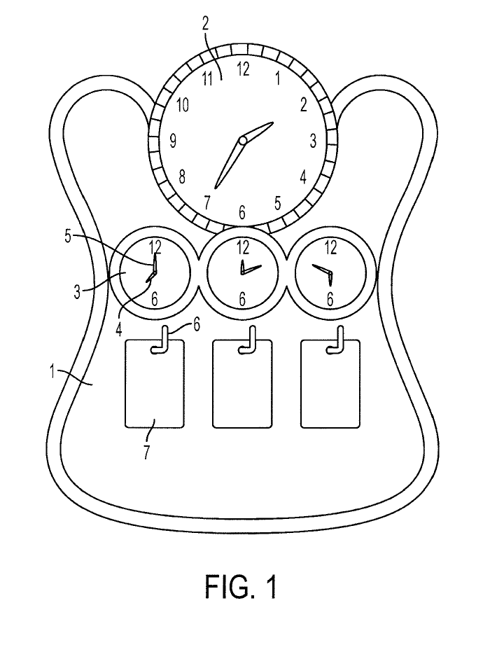

FIG. 1 shows an embodiment of a planning system (or kit) according to the invention. The kit may include a base 1 which may include a large functioning clock 2. The clock 2 may be located in a plurality of locations on the base 1. FIG. 1 shows the clock 2 at the top center of the base 1.

The clock 2 may be represented in various clock styles and forms. The clock may be analog or digital. The base 1 also includes at least one faux or non-functioning clock 3. The non-functioning clock 3 maintains a specified time. The non-functioning clock may also be analog or digital. FIG. 1 shows the non-functioning clock 3 embodied as an analog clock with moveable arms 4, 5. The non-functioning clock 3 may be set to the specified time with the movable arms 4, 5. Alternate embodiments of the invention utilize a digital non-functioning clock 3.

The non-functioning clock 3 may be located in a plurality of locations on the base 1. FIG. 1 includes three non-functioning clocks. The arrangement of the non-functioning clocks may be represented in a horizontal or vertical position, in a linear or non-linear pattern. The non-functioning clock may include the ability to function as a working clock and/or to sound an alarm. In any given embodiment of this invention, alternative devices for indicating set times can be used in place of the non-functioning clocks, including but not limited to, blank spaces that allow dry-erase application, chalkboard for chalk application, magnetic, felt or other attachments that indicate time references.

A replaceable informational item 7 is associated with each non-functioning clock 3. The informational item 7, such as a card, contains information that prompts a behavior. The behavior on the item 7 occurs at the specified time represented by the associated non-function clock 3. When the time of the functioning clock 2 is the same time as the non-functioning clock 3, the behavior on the item 7 may then occur. For example, the informational item 7 may represent 15 minutes of television watching. The non-functioning clock associated with the item 7 may be read 3:00 pm. Once the functioning clock 2 represents 3:00 pm, 15 minutes of television watching may then occur.

Embodiments of the invention may omit the functioning clock 2 coupled to the base 1. Instead, another functioning time piece may be used. The informational item 7 may also be a space that allows dry-erase application, chalkboard for chalk application, or other devices that allow for a behavior to be specified.

An attachment device 6 may be associated with each non-functioning clock 3 and informational item 7. The attachment device 6 attaches the informational item 7 to the base 1. The location of the attachment device 7, such as a hook or clip, can originate from the faux clock or be anchored within the base 1 as is seen in FIG. 1A. Attachment devices may include different shapes, colors, and materials including, but not limited to, plastic, metal, wood or glass. Alternatively, the attachment device may comprise a pocket or other attachment mechanisms, such as VELCRO.

The bottom portion of the base 1 may be a solid board for which to provide support, aesthetics and function in the case of anchoring an attachment device. This part of the apparatus—as with the entire apparatus—may be made of any material including, but not limited to, wood, plastic, metal, magnetic, paper, PVC wood. The device may be any color or design, assume a different shape or dimension. The base 1 may be omitted entirely, as in the instance where attachment devices are adhered directly on to the non-functioning clock 3 or any structure related to the apparatus. For example, the non-functioning clock and associated informational item may have magnetic attachment devices and may be magnetically attached to a refrigerator door, thus eliminating the need of a base 1. In embodiments of the invention, the device may comprise any feature described either individually or in combination with any other feature, in any configuration and process.

The informational items may be associated with the non-functioning clock 3. The informational items may include a plurality of categories. For example, there may be a plurality of cards related to “Snacks,” “Activity,” and “Homework time.” A category of “After School” may be provided which may include cards from snacks, activity, and homework categories. Other categories of informational items may be contemplated.

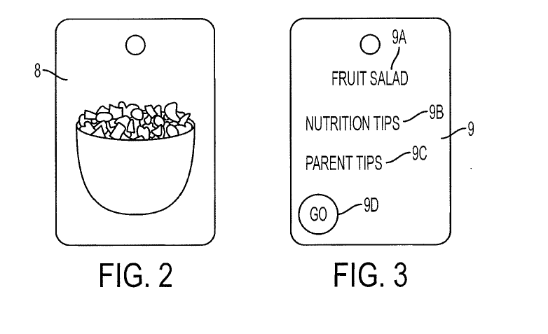

The informational items of the Snack category include a snack choice on a first side, and a summary of nutritional facts and tips on the second side, as shown in FIGS. 2 and 3. The second side provides important information and tips to educate children and caregivers.

The snack informational items may be color-coded depending on the snack's nutritional value. Green cards symbolize ‘Go’ snacks and represent healthy snacks. Such healthy snacks contain nutrients that are required for optimal growth and health—as explained on the second side 9. An example of a healthy snack is an apple. Yellow cards symbolize “go slow” foods and incorporate more mainstream processed snack items that have been modified (baked, reduced sodium, low fat, etc). An example of a yellow food is baked chips. Red cards symbolize “stop and think” foods. Red cards are intended for the caregiver to administer as an option on rare occasions. These snack/food items are considered highly processed and are known contributors to the epidemic of obesity in children in addition to dental concerns. An example of a red food is a chocolate candy bar. The red cards are provided to educate the parents on the risks of over indulgence of these foods in their children's diet.

The informational items may be made of any material including, but not limited to, paper, cardboard, wood, fabric, metal, stone and glass. A picture and phrases may represent the food, activity, or homework task. The picture may be a photograph or illustration, in color or in black and white. The opposing side of the card may contain useful information as outlined above, or may appear blank. The informational cards for snacks may include various themes, ethnic cuisine, food allergies and intolerances, or calorically specific. Blank cards may be included in addition to the depicted cards for individual use by a parent or child, with a surface that accepts writing and is adjustable for reuse. Each card has an opening to where it would attach on the apparatus, as to where it would hang on a hook, or would comply with the requirements of alternative devices of display including Velcro, clips, and magnetic adherence.

FIGS. 2-6 represent examples from the Snack category. FIG. 2 shows a first side of an informational item 7 with a picture 8 of a bowl of fruit salad. FIG. 3 shows a second side 9 of the informational item 7 shown in FIG. 2. The second side displays the name of the snack “Fruit Salad” 9A, displays the nutritional tips 9B, the tips from the caregiver 9C, and the value of the snack 9D. As indicated in the value 9D, the fruit salad snack is a ‘Go’ food.

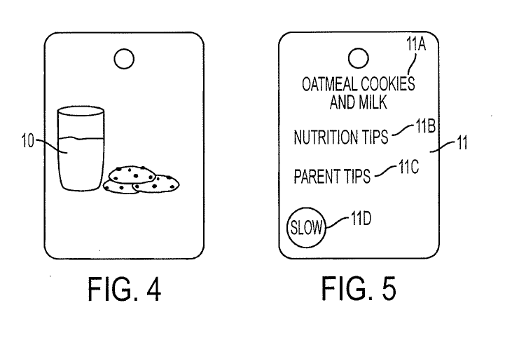

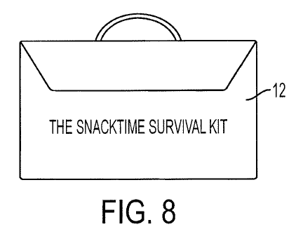

FIGS. 4 and 5 represent a yellow snack. The snack is depicted in an illustration on the first side 10 of the informational item. FIG. 5 displays the second side 11 of the informational item. The second side 11 displays the name of the snack “Oatmeal Cookies and Milk” 11A, the nutritional tips 11B, the caregiver tips 11C, and the value of the snack 11D. As indicated in the value 11D, the “Oatmeal Cookies and Milk” snack is depicted as a yellow “slow” food. FIG. 8 represents a device that houses the informational items for the snack category.

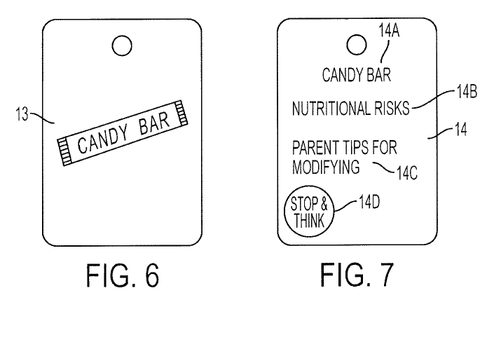

FIGS. 6 and 7 represent a red snack. The snack is depicted as a candy bar on the first side 13 of the informational item, shown in FIG. 6. FIG. 7 displays the second side 14 of the informational item. The second side 14 displays the name of the snack “Candy Bar” 14A, the nutritional tips 14B, the caregiver tips 14C, and the value of the snack 14D. As indicated in the value 14D, the “Candy Bar” snack is depicted as a red “stop and think” food. FIG. 8 represents a device that houses the informational items for the snack category.

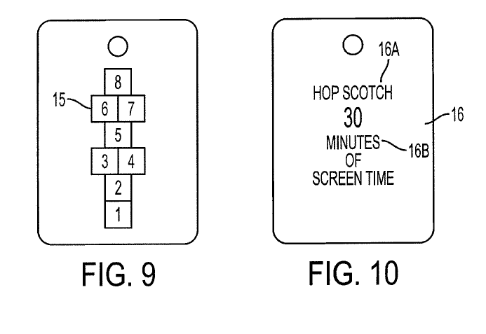

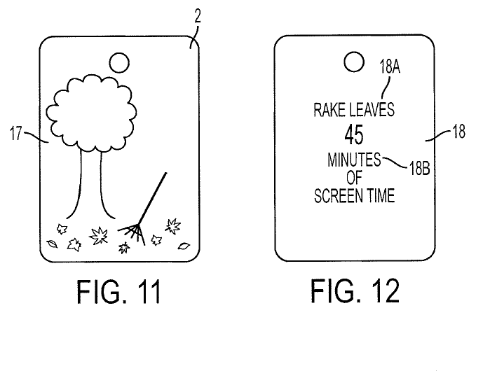

FIGS. 9-12 depict a card included in the Activity category. The first side of the card (FIG. 9) depicts a physical activity 15 illustrated as hop scotch. Other examples of activities include, but are not limited to, jumping rope, bicycle riding, playing tag, playing ball, dancing, imaginary play, or sports. Other activities depicted on the front of these cards may include physical household duties or “chores” such as vacuuming, dusting, folding laundry, helping with the dishes, cleaning bedroom, cleaning playroom, making bed, putting clothes away, bringing out the garbage, raking leaves, etc. FIG. 11 depicts another example of an informational item from the activity category. Raking leaves is illustrated on the first side 17 of this informational item as depicted in FIG. 11.

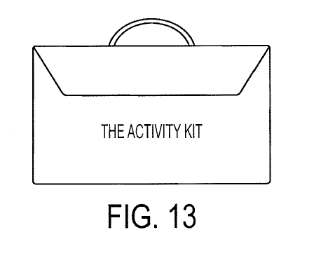

On the second side of each physical activity card will be a time increment corresponding to screen time allowed for that given day, as shown in FIGS. 10 and 12 which correspond to FIGS. 9 and 11, respectively. As depicted in FIG. 10, the second side 16 displays the name of the activity “Hop Scotch” 16A and the amount of screen time allocated 16B for completing the activity as “30 minutes.” As depicted in FIG. 12, the second side 18 displays the name of the activity “Rake Leaves” 18A and the amount of screen time allocated as “45 minutes” 18B for completing the activity. FIG. 13 represents a device that houses the activity category informational items.

Screen times may be divided into increments of 15 minutes, 30 minutes and 45 minutes—depending on the physical requirements of that particular activity. For example, raking leaves may take up to an hour of physical expenditure, so the maximum allowance of time awarded for that activity would be 45 minutes. In contrast, making the bed is not as physically intensive or time intensive and would be allotted the smaller allowance of 15 minutes. The goal, however, is to remain below 2 hours each day, to comply with the Academy of Pediatrics recommendations. This engages the child in actively strategizing the set activities to maximize the time allowance for his or her desired outcome.

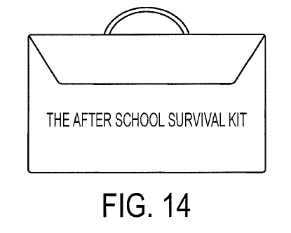

FIGS. 14-16 depict the cards included in the After-School category which include three subcategories of events that typically take place after a school day. These subcategories include snack, homework, and activity events.

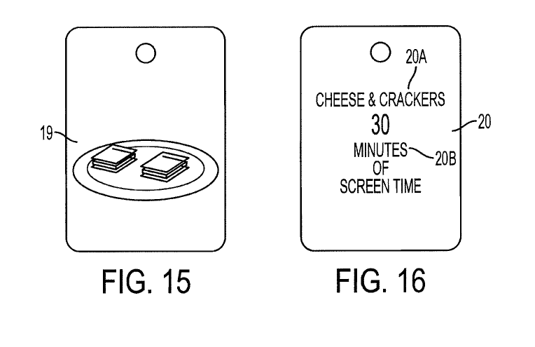

As provided in the example of FIGS. 15 and 16, the snack subcategory includes an informational item having a first side 19 depicting a snack and a second side 20 having the name of the snack 20A and a reward 20B, such as screen time. The second side 20 may also include the nutritional information and tips. The reward of screen time may include, but is not limited to, watching a television, playing an electronic game system, or playing on a computer. Other rewards may include financial incentives, stickers, gold stars, or other rewards appealable to child. FIG. 14 represents a device that houses the informational items for the After School category.

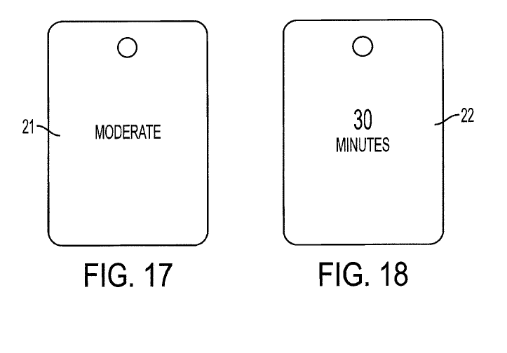

FIGS. 17 and 18 provide examples of informational items from the homework subcategory. The homework informational items may contain a total of 3 cards indicating “light”, “moderate” and “heavy” workloads. The first side 21 displays an example of the moderate workload. The second side 22 reflects a reward of screen time allotted according to the duration it takes to complete the homework for that day. For example, less than 30 minutes may equate to 15 minutes screen time, less than 45 minutes may equate to 30 minutes screen time and over 1 hour may equate to 45 minutes screen time.

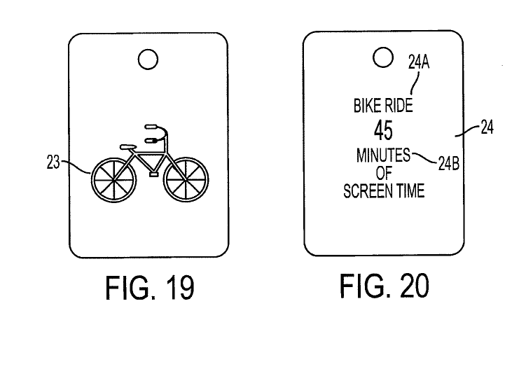

FIGS. 19 and 20 provide examples of informational items from the activity subcategory. The activity subcategory includes informational items of various outside free play activities as well as chores and responsibilities. FIG. 19 displays an illustration of a bike 23 on the first side of the card. FIG. 20 displays the second side 24 of the card in FIG. 19 which states the name of the activity “Bike Ride” 24A with the reward of screen time allotted 24B awarded after the activity. The screen time awarded may correspond to the intensity of the activity.

The content of the subcategory cards may vary in snack choices, descriptions of activities, homework criteria, and screen time allowances, may be depicted by animation or photography, in color or black and white. Each card may include an opening to where it is able to attach on the device.

The informational cards may be altered based on age and grade for which the contents would reflect the appropriate nutrient needs, activity levels and endurance, as well as homework levels for the particular child. The informational cards may also include information relating to diet-specific conditions, diseases or illnesses. Examples of such diseases or illnesses include, but are not limited to, information regarding diabetes, lactose intolerance, celiac disease, food allergies, obesity, attention deficit disorder, and autism spectrum disorders.

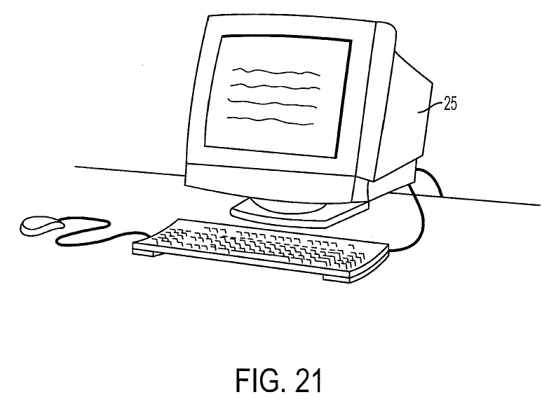

FIG. 21 provides a computer 25 for a caregiver to access an interactive website forum for caregivers to access relevant information about the device and informational cards in a closed community website. With enrollment into the support website, each parent/caregiver is given their own personal page which contains a profile, an option to post photos, videos and widgets, and an optional blog section. Members may remain anonymous or choose to be fully disclosed. “Personal friends” will be an option to communicate directly with “invited” friends within the website community. The interactive website will include a discussion forum for which members can initiate discussions and/or participate in ongoing discussions. The website will also include a links page to helpful resources.

Parents are encouraged to support their child/children's autonomy by providing support and praise, and abstaining from the role of manager. Failure to comply with set events results in the loss of the intended goal—which in most cases is a favorable activity sought out by the child. Accountability lies on the child who is assuming personal responsibility over the board. Parents and caregivers are provided with an interactive web-based community to provide solutions to issues or problems that may arise. An interactive forum will enable parents and caregivers to reach out for help, ask questions, seek tips and advice from other parents and caregivers, as well as professional dietitians and/or child psychologists.

### Overview of when to Use the Device with Snack Informational Items

Toddlers are irrational, emotional and impulsive. Developmentally, most are unable to comprehend time and space and lack the verbal skills to properly express themselves. These developmental deficits can lead to frustration and to the one form of communication they know of, and that is often through crying, screaming and tantrums. However, toddlers are actually active learners and capable of reasoning. By allowing children (especially toddlers) to participate in decisions affecting their own life, they begin the process of developing the skills for reasoning, gain confidence and self-esteem. It is a parent's responsibility to help children expand their abilities to reason by empowering them with decision-making opportunities.

Incessant snacking is a frustrating occurrence that many parents face on a daily basis. Incessant snacking is a contributor to the occurrence of weight gain and obesity in children today. Parents often relent to the incessant demands of snacking due to the inability to “ignore” tantrums, or re-direct toddlers to other activities. The truth of the matter is that children—particularly toddlers and preschool children—do depend on two to three snacks each day to meet their high energy needs that their small stomachs cannot contain in only 3 meals a day.

### Example of when to Use the Device with Snack Informational Items

A mother is cleaning up dishes from breakfast when her young toddler (2-3 years of age) enters the kitchen and asks for a snack. The mother replies, “You just had breakfast a half hour ago.” The young child, frustrated by his incomprehension of time, cannot rationalize what a “half hour ago” means, and begins to feel a lack of control in his present situation. This loss of security leads to frustration, expressed by a whine. He persists on demanding a snack. This time, his mother may use another reference of time incomprehensible to the child, such as “You can have a snack in a half hour. You just had breakfast.” Growing more frustrated by his lack of control, the child's whines turn to crying and eventually a tantrum. By now, the mother is frustrated and may give into the young child, “Just this once. This is the last snack you can have until after lunch.” Again, with no understanding of time and space, the young child might be at it again, insisting on a snack, even before lunch is served.

In order to prevent the above scenario, the device may be used with the snack informational items. Preferably, each morning after breakfast, the mother or caregiver selects 4-5 snack cards that are available to prepare that day. She then presents the child with the 4-5 snack cards and allows him/her to choose 3 snacks for that day. The child then makes the decision for the 3-scheduled snack times that day, and places each snack on one of hooks that correspond to a faux clock. After the child places the snack on hook, the parent or caregiver sets the faux clock at the determined snack times.

For young children, toddlers and preschoolers, the initial days of using this system might be met with the same behaviors exhibited in the previous scenario. This is where the visual picture of each chosen snack comes into play. Parent or caregivers can take the child over to the snack board and point to his or her selected snack, and reaffirm their request by saying . . . “Yes, you are going to get your snack. But first, you have to wait for this small hand to go here and this longer hand to be there . . . . ” This gives the child the visual of time and space. It also validates that their request was heard and understood.

In the beginning stages, before the child can tell time or recognize the scheduled times, the parent or caregiver may have to alert the child when it is snack time. They can bring the child over to the clock, show him or her how the arms are matched with the working clock, and have the child make the announcement that it's snack time. This will empower the child with confidence as well as secure them with the understanding that they have some control over their lives. Eventually, the child will be able to manage the board independently as a schedule or routine develops.

### Overview of when to Use the Device with Activity Informational Items

Children on average spend too much time engaged in sedentary behaviors such as television viewing, video gaming and computer usage. Once these behaviors are established and habitual, parents and caregivers are faced with the daunting challenge of trying to modify, or restrict them. Change is often met with resistance from the child/children as they feel they are being punished for no apparent reason. Parents often lack a ‘back-up plan’ for alternative activities or structure. This often results in the failure to maintain the new rules and the habits resume.

With the device and activity informational items, screen time is allotted through the completion of 3 daily activities, all of which are chosen by the child. At the start of each day, the child (or children) are given a plurality of activity cards (from the survival kit) and are in charge of choosing 3 activities for that given day. The screen time allotment is on the backside of each activity card, in either 15, 30, 45 minutes, depending on the intensity and duration of the activity. The more intense the activity, the greater the screen time allocated.

Most children will want to choose at least one of the more intensive activities as they only have 3 opportunities each day to accrue screen time for that same day. This encourages at least 1 or 2 vigorous activities—whether it's a form of outside free play or engaging in household chores or duties.

After the activities are chosen, the children place them on the hook situated below the faux clock. The scheduled ‘event’ times are set around meals, snacks, school hours and/or any planned appointment that are to take place that day. This system is best suited for young children who attend half-day school such as Kindergarten or preschool, and beneficial for all age groups on weekends. Time accrued is only good for that same day. Time cannot be carried over to the next day or banked for later use. The reason for this is to encourage parents to comply with the Academy of Pediatrics recommendations for 2 or less hours of screen time each day.

For young children who use the snack time survival kit, the screen time survival kit can be used in combination by placing the selected activity underneath the chosen snack. After the snack is eaten, the activity can begin. This is an excellent tool for parents and caregivers to use when developing daily schedules and an invaluable method for instilling healthy eating habits and physical play into the lives of children.

### Overview of when to Use the Device with after School Informational Items

For many families today, unhealthy eating habits and sedentary behaviors are the result of our overextended society. Many parents and caregivers today are single parents, or dual income families that lack the time and ‘hands-on’ involvement to uphold family rules and schedules. Many other households are multi-tasking between sporting events, extracurricular activities and homework, which perpetuates an unorganized and unstructured environment. The fact of the matter is this—there is no “one-size-fits-all” system for creating healthy and productive routines and schedules that meet the diverse needs of all families, in all circumstances. Until now.

The device and After School informational items encompasses the 3 universal needs that take place after school for the majority of children everywhere: a snack, homework and some form of physical activity. For many children and teens today, these 3 events have been hindered in some way by the over-indulgence of television, video gaming and computer use. With the device and After School informational items, children and adolescents are empowered with the responsibility of making their own choices, managing their own time and achieving their own set goals. Completion of these goals comes with the accumulation of screen time minutes, failure to meet goals result in the loss of screen time.

There are 3 specific events that are to take place later on in the day when a child returns home from school. Of these 3 events, only 1 event is decided on before the child/adolescent leave for school that morning, and that is the after school snack. This decision should be made in the morning, preferably after breakfast when the child/adolescent is not hungry.

Poor choices are often made when hunger and fatigue have set in, and children/adolescents returning from school are often hungry and fatigued. Because unhealthy snacks are an option to the child (however with the sacrifice of forfeiting 15 screen time minutes) this decision is better thought out and reasoned when they are not already hungry or ‘craving’ salty and sweet snacks. Their decision to choose a more substantial and healthy snack, which are allotted higher screen time minutes, are more likely when planned ahead of time. Once the snack is chosen—regardless of it being healthy or not—the parent is to respect the decision, and the child accepts accountability for their decision—regardless if they ‘change their mind’ after school.

In this event, it is recommended that parents handle the situation by allowing the child to choose another snack of equal nutritional value (another green or yellow card) but with the deficit (instead of allotment) of that snack's screen time minutes. Because the goal was not properly met, the child is held accountable for losing the screen time minutes on that event. Personal responsibility must be encouraged not just when goals are met, but when they are broken as well.

It is up to the parent or caregiver to ensure that the snack is available and/or prepared for the child once he/she returns from school The snack being decided, the child leaves for school and returns with his first event (the snack) available. Out of the 3 scheduled events, the snack is the only event that is ‘fixed’ as being the first to take place. This is due to the fact that energy levels are often low at this time of the day, by ‘re-fueling’ on a substantial and healthy snack, energy levels pick up, which is necessary for carrying out the other 2 events: homework and physical activity.

After the snack has finished, the child then is provided with a plurality of cards from the survival kit that include several options for physical activity as well as the option to complete homework before or after the activity. The incentive for completing homework first, following a healthy snack when mental energy levels are at an optimum, is the allotment of 15 free minutes of screen time. The intensity or workload of the homework is also a way for allocating screen time. Depending on the age and grade level of the child, screen time is allocated in relation to the amount of time to thoroughly complete that day's homework. This encourages children to take their time and avoid rushing because the longer it takes to complete their homework; the more screen minutes are allocated.

Parents are encouraged to play an active role in looking through their child's assignments and checking the quality of their work. This helps build a connection between children and parents, and builds a child's security and work ethic. Physical activity cards vary from outdoor play to inside chores, dancing and playing to sports and imaginary play. Screen time is determined by the intensity of each activity, which might encourage an intensive physical expenditure in order to recoup the full 45 minutes of screen time.

The child then places their desired event choices on the hook beneath the faux clock and the parent/caregiver designates the appropriate times based on input from the child. Because the child at this point may have already earned as much as 30 minutes of screen time (depending on the chosen snack) he or she may choose to use the 30 minutes immediately after the snack or wait and ‘bank it’ for later on, after all events have been completed.

Parents or caregivers may also choose to sit down the night before with the child and pre-determine the times and chosen events for the next day. This alteration in the system may benefit families that have working parents and ‘latchkey’ children. For these families, this scenario still allows for the child to make the decisions and be the keeper of his or her own time. This scenario puts personal responsibility to the test, and parents are encouraged to remain subjective and non-authoritarian if their children fail to meet set goals. This situation may provide an opportunity to discuss the consequences from their decisions.

This above situation may warrant some concerns or frustrations on the part of the parent or caregiver who can then seek out advice from the interactive forum to which they are members of. By starting the discussion about working parents and obstacles for encouraging compliance, the parent or caregiver can receive support from parents who are in the same situation and can offer empathy, advice and tips. The support and feedback then gives the parent/caregiver new motivation and a different approach to working out some of the kinks in her current situation. She shares them with her child who may agree to some of the modifications. This renews the child's sense of personal responsibility, autonomy and self worth through the validation of his parents/caregivers. The system averts failure due to the ongoing support and system received by all both child and parent/caregiver.

It will be understood that the above description of the present invention is susceptible to various modifications, changes and adaptations, and the same are intended to be comprehended within the meaning and range of equivalents of the appended claims.

What is claimed is:

1. A planning system, comprising:
at least one non-functioning clock, wherein each of the at least one non-functioning clocks includes a settable hour placeholder and a settable minute placeholder in order to represent a specified time; and
at least one informational item adapted to be associated with the at least one non-functioning clock, each item containing information relating to at least one of a food, activity, homework, or combination thereof and additional information to prompt a behavior of an individual at the specified time.

2. A planning system according to claim 1, wherein the additional information includes a positive reward allotment.

3. A planning system according to claim 1, wherein the informational item comprises a blank area adapted to receive erasable writing from a writing utensil.

4. A planning system according to claim 1, further comprising a holding device to house a set of informational items when the informational items of the set are not associated with the at least one non-functioning clock.

5. A planning system according to claim 1, wherein a plurality of informational items comprise a set of items, the set including categories relating to one of food, activity, or after school activity.

6. A planning system according to claim 1, wherein the informational items comprise cards.

7. A planning system according to claim 1, wherein the informational items with information relating to a food are color coded, wherein each color corresponds to the nutritional value of the food.

8. A planning system according to claim 2, wherein the reward allotment comprises screen time on an electronic device.

9. A planning system according to claim 6, wherein each card includes a first side and a second side, the first side depicting an illustration of the food, activity, homework, or combination thereof, and the second side to provide information relating to the food, activity, homework, or combination thereof.

10. A planning system according to claim 1, further comprising three non-functioning clocks, each non-functioning clock including an attachment device, the attachment device adapted to attach one of the informational items in association with one of the non-functioning clocks.

11. A planning system according to claim 1, wherein the activity includes a physical activity and associated screen time on an electronic device.

12. A planning system according to claim 8, wherein an amount of the associated screen time corresponds to a level of intensity or value of the food, activity, homework, or combination thereof.

13. A planning system according to claim 1, further comprising:
a base surface, wherein the at least one non-functioning clock and the at least one informational item are coupled to the base surface.

14. A planning system according to claim 13, further comprising:
a working clock.

15. A planning system according to claim 14, wherein the working clock is arranged on the base surface.

16. A planning system according to claim 1, further comprising: at least one attachment device mounted on the base and adapted to attach one of the informational items in association with one of the non-functioning clocks.

17. A planning system according to claim 16, wherein the attachment device comprises one of VELCRO, clip, glue, hook, pin, or a magnetic device.

18. A planning system according to claim 1, wherein the informational items include information relating to managing a diet-specific condition, a disease, or an illness.

19. A method for planning, comprising utilizing the system of claim 1.

20. A method for planning, comprising: setting an hour-hand placeholder and a minute-hand placeholder of at least one non-functioning clock to represent a specified time in relation to a working clock in real-time;
choosing an informational item from a predetermined set of informational items relating to at least one of a food, activity or homework;
associating the informational item with the specified time of the at least one non-functioning clock; and
completing a task associated with the informational item when the specified time of the non-functioning clock is the same time as the working clock.

21. A method according to claim 20, further comprising:
assigning a reward to at least one of the informational items.
